(19) United States
(12) Patent Application Publication
(10) Pub. No.: US 2003/0015565 A1
(43) Pub. Date: Jan. 23, 2003

(54) Automatic cutting and feeding device for serially connected caps for a fastening tool

(76) Inventor: Yun-Chung Lee, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/909,724

(22) Filed: Jul. 19, 2001

(51) Int. Cl. B25C 7/00

(52) U.S. Cl. 227/18; 227/135

(57) ABSTRACT

An automatic cutting and feeding device for serially connected caps for a fastening tool, the device comprises a cap seat between a triggering device and a handle for cutting the serially connected caps, a rail set for delivering the serially connected caps and a receiving box for placing therein the serially connected caps. By cooperation of the rail set and the triggering device, the serially connected caps can be continuously sent into the cap seat; and by cooperation of the triggering device and the cap seat, the serially connected caps can be separated and accurately cut for fastening a thin sheet; thereby, the object of automatic cutting and feeding the serially connected caps can be achieved.

### BACKGROUND OF THE INVENTION

1. Field of the Invention

The present invention is related to an automatic cutting and feeding device for serially connected caps for a fastening tool; and especially to such a device, wherein, by cooperation of a triggering device and a cap seat, the serially connected caps can be accurately cut for fastening a thin sheet; and by cooperation of a rail set and the triggering device, the serially connected caps can be continuously sent into the cap seat. Thereby, an object of automatic cutting and feeding the serially connected caps can be achieved.

2. Description of the Prior Art

An automatic feeding device for serially connected caps made according to the design of the U.S. Pat. No. 6,145,725 has been in the markets presently, wherein, the serially connected caps are placed in a receiving box, and an automatic feeding device is used to automatically send the serially connected caps to a position below a triggering device, then the triggering device cuts the serially connected caps for fastening a thin sheet.

It has been known that in practical using, the mode purely using the punching force in fastening to cut the serially connected caps for fastening a thin sheet is subjected to inability of smoothly cutting the serially connected caps by inadequate punching force created in fastening, this makes inconvenience for users.

Therefore, the inventor provides the present invention in view of the above stated problem after hard study based on his specific experience of years in study, development, production and selling in the related products.

### SUMMARY OF THE INVENTION

The object of the present invention is to provide an automatic cutting and feeding device for serially connected caps for a fastening tool, wherein, the serially connected caps can be accurately cut for fastening a thin sheet; and the serially connected caps can be continuously sent into the cap seat. Thereby, an object of automatic cutting and feeding the serially connected caps can be achieved.

To this object, the present invention takes the following features of technique:

At least a cap seat for cutting the serially connected caps between a triggering device and a handle, a rail set for delivering the serially connected caps and a receiving box for placing therein the serially connected caps. By cooperation of the rail set and the triggering device, the serially connected caps can be continuously sent into the cap seat; and by cooperation of the triggering device and the cap seat, the serially connected caps can be separated and accurately cut for fastening a thin sheet; thereby, the object of automatic cutting and feeding the serially connected caps can be achieved.

The present invention will be apparent in obtaining the object thereof after reading the detailed description of the preferred embodiment thereof in reference to the accompanying drawings.

### BRIEF DESCRIPTION OF THE DRAWINGS

FIG. 1 is a front view of the present invention;

FIG. 2 is an analytic perspective view of the present invention;

FIG. 3 is a partial sectional schematic view showing operation between the present invention and the triggering device;

FIG. 4 is another partial sectional schematic view showing operation between the present invention and the triggering device;

FIG. 5 is a further partial sectional schematic view showing operation between the present invention and the triggering device;

FIG. 6 is a sectional view showing a part of the present invention;

FIG. 7 is another sectional view showing a part of the present invention.

### DETAILED DESCRIPTION OF THE PREFERRED EMBODIMENT

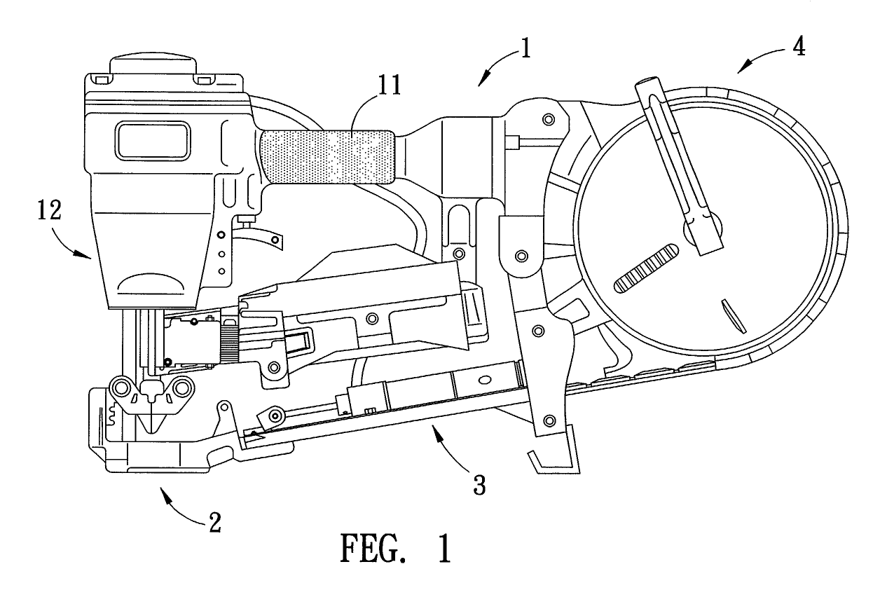

Referring to FIG. 1, the automatic cutting and feeding device for serially connected caps for a fastening tool 1 of the present invention includes at least: a cap seat 2 between a triggering device 12 and a handle 11 of the fastening tool 1 for cutting the serially connected caps 6, a rail set 3 for delivering the serially connected caps 6 and a receiving box 4 for placing therein the serially connected caps 6, wherein:

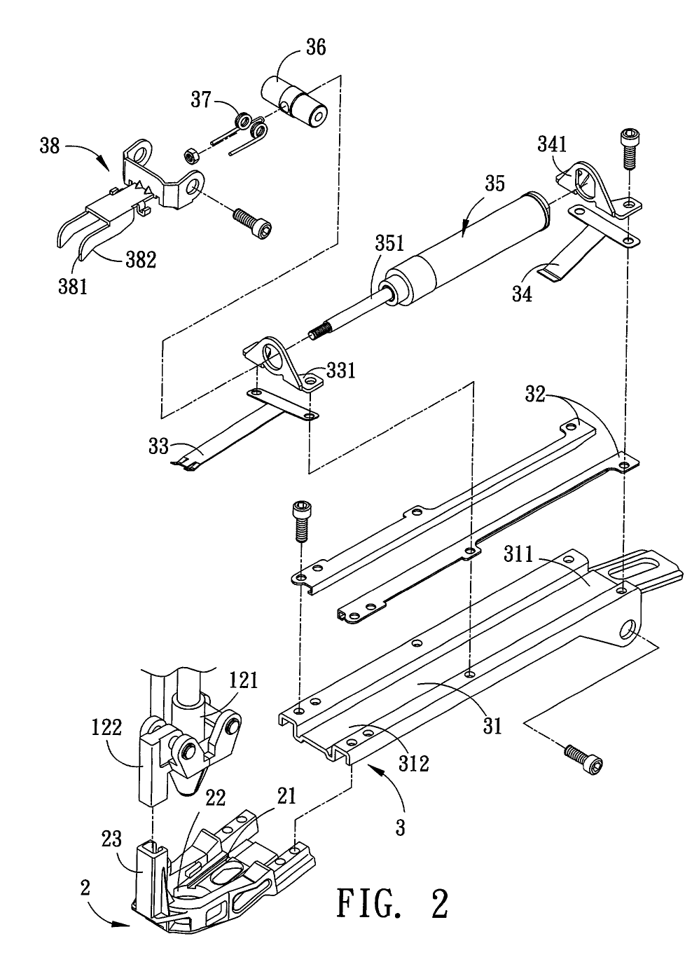

The cap seat 2 is provided below the triggering device 12 (as shown in FIG. 1), and is provided thereon with a rail rest 21 of which one end is connected to a cap outlet end 312 of a track 31 of the rail set 3 while the other end is provided with a round hole 22 slightly larger than a cap 6, the rail rest 21 allows the serially connected caps 6 to pass therethrough to the round hole 22. The round hole 22 is located below a punching head 121 of the triggering device 12, and has a vertical wall surface 221 with a predetermined height. The cap seat 2 is provided on one end thereof near the round hole 22 with an upright groove 23 to be fitted therein a positioning member 122 of the triggering device 12 (as shown in FIG. 2).

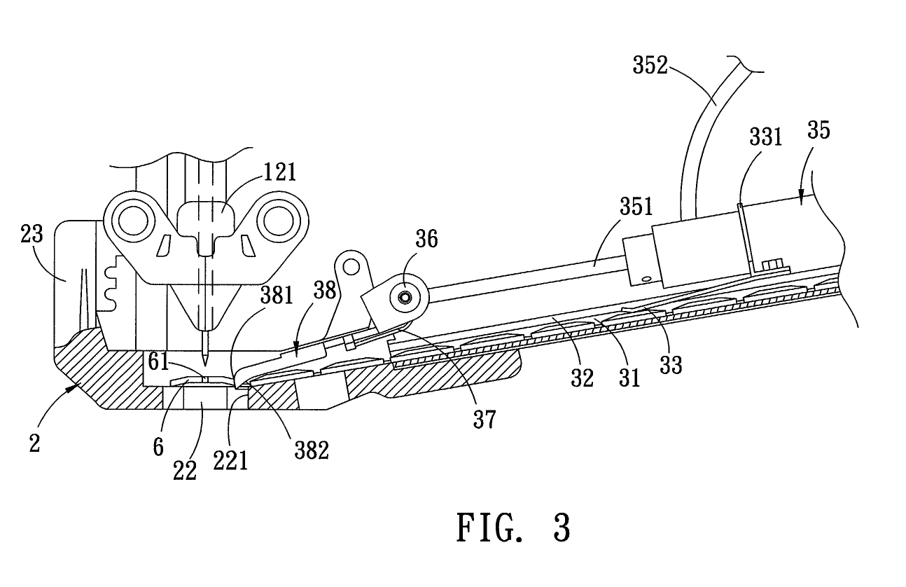

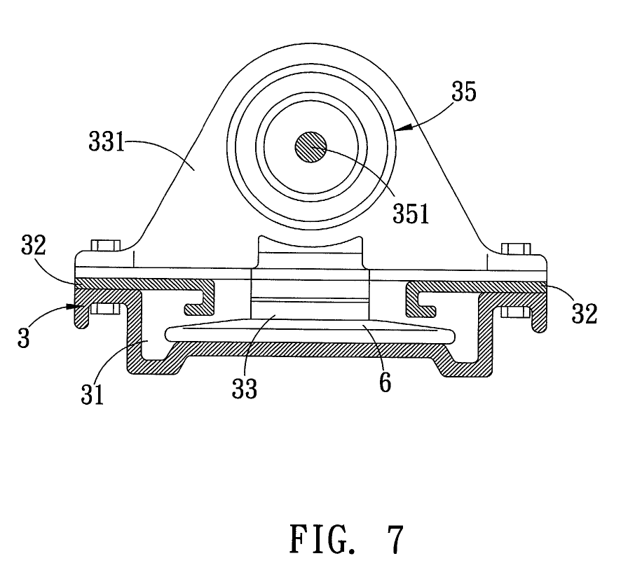

The rail set 3 is provided exactly below the handle 11 of the fastening tool 1 (as shown in FIG. 1), and is provided with the track 31, both sides thereof are provided with a press plate 32 (as shown in FIG. 7). The cap outlet end 312 of the track 31 is connected to the rail rest 21 of the cap seat 2, while an inlet end 311 of the track 31 is connected to an output port 41 of the receiving box 4; the track 31 is further provided respectively with a first compression spring 33 and a second compression spring 34 to press the serially connected caps 6 in such a way as to move stably in the track 31, the first compression spring 33 is mounted thereabove with a first fixing member 331, and the second compression spring 34 is mounted thereabove with a second fixing member 341. An air pressure cylinder 35 is mounted between the first fixing member 331 and the second fixing member 341, the air pressure cylinder 35 is provided with a pusher rod 351, and is provided with an air pressure pipe 352 connected to the triggering device 12, the pusher rod 351 is connected to a pivot axle 36 on which a spring 37 and a feeding claw 38 mount. The spring 37 is mounted with the other end thereof on the feeding claw 38 of which the front end 381 has vertical claw surfaces and the rear end 382 has inclined claw surfaces (referring to FIGS. 2 and 3).

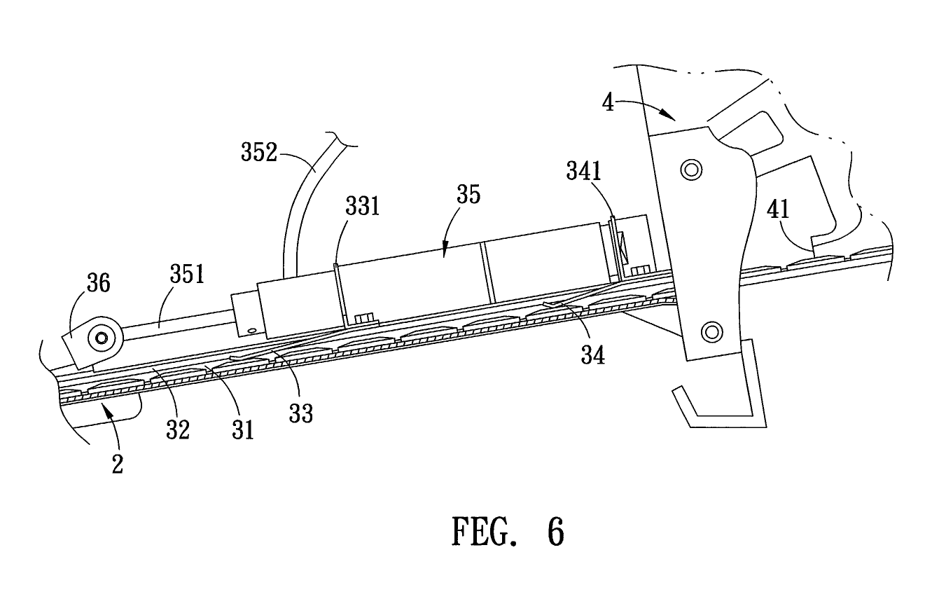

The receiving box 4 is provided at the tailing end of the handle 11, and is a reel-type receiving box for the serially connected caps; the output port 41 of the receiving box 4 is connected to the cap outlet end 312 of the track 31 of the rail set 3 (as shown in FIG. 6).

By combination of the above stated elements, in automatic cutting and feeding operation of the serially connected caps 6, the serially connected caps 6 are pulled out from the reel-type receiving box 4, by forwarding of the track 31 of the rail set 3 toward the rail rest 21 of the cap seat 2 (as shown in FIG. 7) and stopping at the round hole 22 on the other end of the rail rest 21 (referring to FIGS. 3 and 6), the automatic cutting and feeding operation of the serially connected caps 6 can be completed (as shown in FIG. 3).

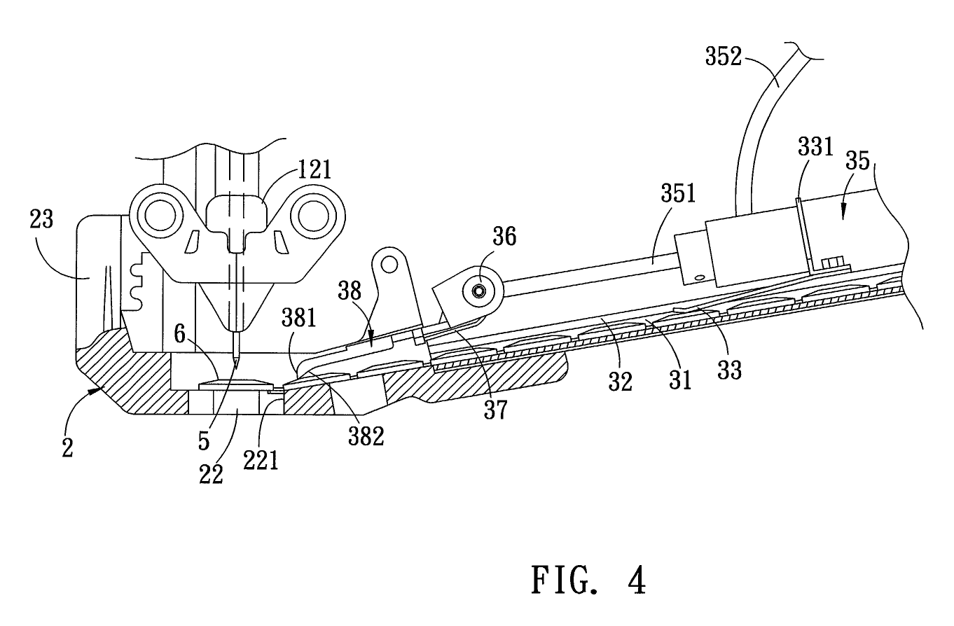

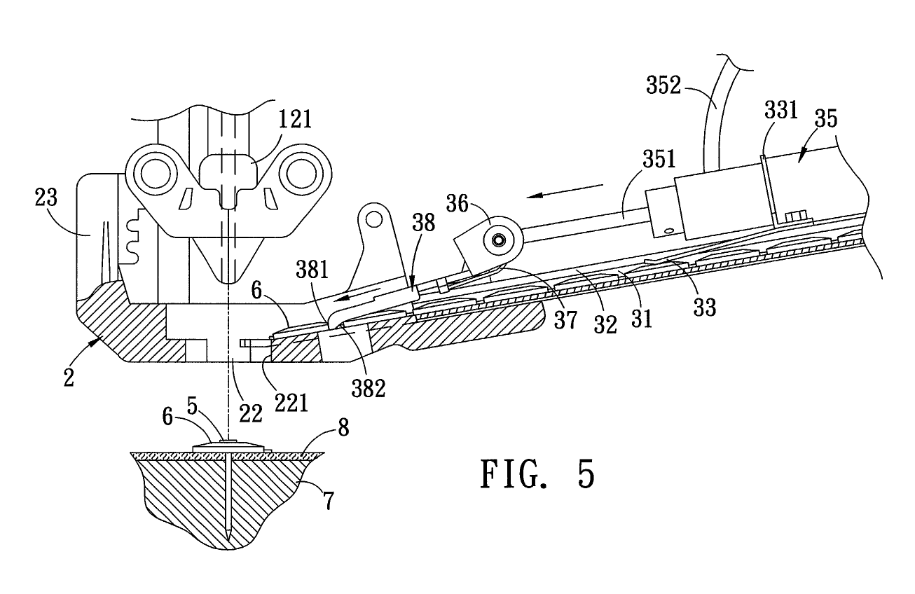

When the triggering device 12 takes advantage of the transient air pressure to forcedly shoot a fastener 5 in the punching head 121, the fastener 5 will be fast shot to the center 61 of a cap of the serially connected caps 6 in the round hole 22. By the downward action force created by shooting the fastener 5 by the air pressure, the cap 6 in the round hole 22 is pulled downwardly, taking advantage of the height of the vertical wall surface 221 of the round hole 22, connections between neighboring caps 6 are cut down, so that the fastener 5 can be shot onto a thin sheet 8 and an article 7 together with the cap 6 in the round hole 22, and automatic cutting operation of the serially connected caps 6 can be completed (referring to FIGS. 4 and 5).

When the triggering device 12 takes advantage of the transient air pressure to forcedly shoot a fastener 5 in the punching head 121, partial air pressure in the triggering device 12 will flow toward the air pressure cylinder 35 through the air pressure pipe 352 to push the air pressure cylinder 35 backwardly and to compress the spring in the air pressure cylinder 35 to move the pusher rod 351 and the pivot axle 36 backwardly, so that the feeding claw 38 pivotally provided on the pivot axle 36 is moved backwardly too; further by virtue that the rear end 382 of the feeding claw 38 is inclined, the feeding claw 38 can be easily slide to the position above the cap 6 along the inclined surface (as shown in FIG. 4).

When the feeding claw 38 slides to be over a position between two foremost caps 6, by the downward force of the spring 37 between the pivot axle 36 and the feeding claw 38, the feeding claw 38 is pressed down to the position between two foremost caps 6, while the triggering device 12 has been recovered its state as that before triggering (as shown in FIG. 5).

Now, the air pressure in the air pressure cylinder 35 for pressing the latter disappears, by restoring of the spring in the air pressure cylinder 35, the air pressure cylinder 35 moves forwardly to also move the pusher rod 351 and the pivot axle 36 forwardly; and by providing the vertical claw surfaces on the front end 381 on the feeding claw 38 of the pivot axle 36, the cap 6 can be easily pushed forwardly into the round hole 22 of the cap seat 2 (as shown in FIG. 3) rather than slides to the position over the cap 6, and automatic feeding operation of the serially connected caps 6 can be completed.

By the above sequential process flow, the object of automatic cutting and feeding the serially connected caps for a fastening tool can be easily accomplished with the automatic cutting and feeding device of the present invention.

The embodiment cited above is only for illustrating the present invention, and not for giving any limitation to the scope of the present invention. It will be apparent to those skilled in this art that various modifications or changes made without departing from the spirit, scope and characteristic of this invention shall also fall within the scope of the appended claims and are intended to form part of this invention.

Accordingly, the automatic cutting and feeding device for serially connected caps for a fastening tool of the present invention can surely accomplish the object of automatic cutting and feeding the serially connected caps.

Having thus described my invention which is novel and advanced, what I claim as new and desire to be secured by Letters Patent of the United States are:

1. An automatic cutting and feeding device for serially connected caps for a fastening tool, said device comprises a cap seat between a triggering device and a handle for cutting said serially connected caps, a rail set for delivering said serially connected caps and a receiving box for placing therein said serially connected caps, and is characterized by that:
said cap seat is provided below said triggering device, and is provided thereon with a rail rest of which one end is connected to a cap outlet end of a track on said rail set while the other end is provided with a round hole slightly larger than any one of said caps, said rail rest allows said serially connected caps to pass therethrough to said round hole; said round hole is located below a punching head of said triggering device, and has a vertical wall surface with a predetermined height;
said rail set is provided exactly below said handle of said fastening tool, and is provided with said track to allow said serially connected caps to pass therethrough, said cap outlet end of said track is connected to said rail rest of said cap seat, while an inlet end of said track is connected to an output port of said receiving box;
said track is further provided with an air pressure cylinder, said air pressure cylinder is provided with a pusher rod which in turn is provided with a feeding claw, and is provided with an air pressure pipe connected to said triggering device;
said receiving box is provided at the tailing end of said handle of said fastening tool, and is a reel-type receiving box for said serially connected caps; said output port of said receiving box is connected to said cap outlet end of said track of said rail set.

2. An automatic cutting and feeding device for serially connected caps for a fastening tool as claimed in claim 1, wherein,
both sides of said rail set are provided with a press plate to restrain said serially connected caps in such a way as to move stably in said track.

3. An automatic cutting and feeding device for serially connected caps for a fastening tool as claimed in claim 1, wherein,
said track is further provided at least with a compression spring to press said serially connected caps in such a way as to move stably in said track.

4. An automatic cutting and feeding device for serially connected caps for a fastening tool as claimed in claim 1, wherein,
said feeding claw has on the front end thereof vertical claw surfaces in favor of pushing said serially connected caps for feeding.

5. An automatic cutting and feeding device for serially connected caps for a fastening tool as claimed in claim 1, wherein,
said feeding claw has on the rear end thereof inclined claw surfaces to smoothly slide on serially connected caps.

6. An automatic cutting and feeding device for serially connected caps for a fastening tool as claimed in claim 1, wherein,
a spring is provided between said feeding claw and said pusher rod in order that said feeding claw pivotally mounted on said pusher rod has the ability of pressing and pushing to feed said serially connected caps.
